(19) United States
(12) Patent Application Publication
(10) Pub. No.: US 2024/0330621 A1
(43) Pub. Date: Oct. 3, 2024

(54) COMMUNICATION APPARATUS AND COMMUNICATION METHOD

(71) Applicant: TOSHIBA TEC KABUSHIKI KAISHA, Tokyo (JP)

(72) Inventors: Hiroyuki Ishikawa, Sunto Shizuoka (JP); Sadatoshi Oishi, Fuji Shizuoka (JP)

(21) Appl. No.: 18/508,269

(22) Filed: Nov. 14, 2023

(30) Foreign Application Priority Data
Apr. 3, 2023 (JP) 2023-060215

(51) Int. Cl. G06K 7/10; G06K 19/07

(52) U.S. Cl. CPC G06K 7/10366; G06K 19/0723

(57) ABSTRACT

A communication apparatus according to an embodiment includes a movement control unit, an acquisition unit, and a determination processing unit. The movement control unit controls movement of a relative position of an antenna with respect to a wireless tag. The acquisition unit acquires, based on a radio wave of the wireless tag received by the antenna, a plurality of pieces of tag data on the wireless tag at a plurality of relative positions of the antenna. The determination processing unit determines, based on the plurality of pieces of tag data on the wireless tag, which range among a first range, a second range, and a third range between the first range and the second range the wireless tag is within.

### CROSS-REFERENCE TO RELATED APPLICATION

This application is based upon and claims the benefit of priority from Japanese Patent Application No. 2023-060215, filed Apr. 3, 2023, the entire contents of which are incorporated herein by reference.

### FIELD

Embodiments described herein relate generally to a communication apparatus and a communication method.

### BACKGROUND

There is an apparatus that determines, when an antenna receives a radio wave transmitted from a wireless tag attached to an article, which range of a first range and a second range the wireless tag is within. Such an apparatus moves the antenna to detect a phase of the wireless tag. The apparatus determines which range of the first range and the second range the wireless tag is within based on an aspect of the detected phase.

If a distance between the first range and the second range is small, an aspect of a phase detected for the wireless tag on an edge of the first range may be similar to a phase in the second range. In this case, the apparatus may not determine that the wireless tag on the edge of the first range is within the first range. If the first range and the second range are in contact with each other, such a possibility further increases.

If a person attempts to place an article attached with a wireless tag or a container containing the article within the first range, the article or the container may protrude from the first range. If the article or the container protrudes between the first range and the second range, the wireless tag attached to the article may also protrude between the first range and the second range. An aspect of a phase detected for the wireless tag may be more similar to a phase in the second range than an aspect of a phase in the first range, depending on a position of the wireless tag. In such a case, the apparatus determines that the wireless tag is within the second range. However, since the wireless tag is originally to be placed in the first range, it is not preferable to determine that the wireless tag is within the second range.

### DESCRIPTION OF THE DRAWINGS

FIG. 1 illustrates a block diagram of an example of a configuration of a communication system according to an embodiment.

FIG. 2 illustrates a block diagram of an example of a configuration of a reading apparatus according to the embodiment.

FIG. 3 illustrates an example of a data structure of measurement data according to the embodiment.

FIG. 4 illustrates a block diagram of an example of a configuration of a drive apparatus according to the embodiment.

FIG. 5 illustrates a schematic diagram for explaining the drive apparatus.

FIG. 6 illustrates a schematic diagram for explaining a first range, a second range, and a third range according to the embodiment.

FIG. 7 illustrates a schematic diagram for explaining the first range, the second range, and the third range.

FIG. 8 illustrates a schematic diagram for explaining a positional relationship between the first range and a movement range of an antenna according to the embodiment.

FIG. 9 illustrates a block diagram of an example of a configuration of a terminal according to the embodiment.

FIG. 10 illustrates a flowchart of an example of a determination process performed by a processor of the reading apparatus.

FIG. 11 illustrates a position of a wireless tag according to the embodiment.

FIG. 12 illustrates an example of a plurality of pieces of phase data on the wireless tag placed in the first range.

FIG. 13 illustrates an example of a plurality of pieces of phase data on the wireless tag placed in the second range.

FIG. 14 illustrates another example of the plurality of pieces of phase data on the wireless tag placed in the second range.

FIG. 15 illustrates a flowchart of an example of a display process performed by a processor of the terminal.

FIG. 16 illustrates an example of an input image displayed on a display device of the terminal.

FIG. 17 illustrates a flowchart of an example of a trained model generation process performed by the processor of the reading apparatus.

FIG. 18 illustrates a block diagram of a modification of the communication system.

FIG. 19 illustrates a block diagram of an example of a configuration of an inference apparatus according to the embodiment.

### DETAILED DESCRIPTION

An aspect is to provide a technique for improving the determination accuracy of a positional relationship of a wireless tag with respect to a predetermined range.

A communication apparatus according to an embodiment includes a movement control unit, an acquisition unit, and a determination processing unit. The movement control unit controls movement of a relative position of an antenna with respect to a wireless tag. The acquisition unit acquires, based on a radio wave of the wireless tag received by the antenna, a plurality of pieces of tag data on the wireless tag at a plurality of relative positions of the antenna. The determination processing unit determines, based on the plurality of pieces of tag data on the wireless tag, which range among a first range, a second range, and a third range between the first range and the second range the wireless tag is within.

### Embodiment

Hereinafter, a communication system according to an embodiment will be described with reference to the drawings. In the drawings to be used in the following description of the embodiment, a scale of each part may be appropriately changed. The drawings used in the description of the following embodiment may show a configuration in an omitted manner for the sake of description.

### Configuration Example

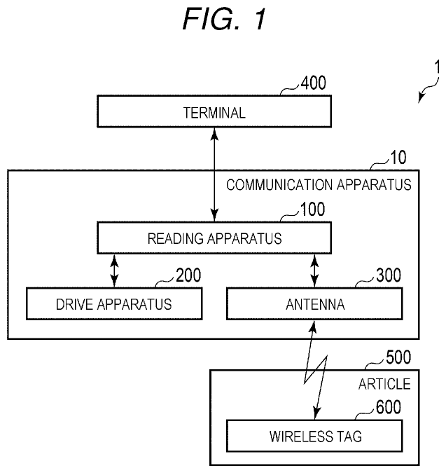

FIG. 1 illustrates a block diagram of an example of a configuration of a communication system 1.

The communication system 1 includes a communication apparatus 10, a terminal 400, and one or more wireless tags 600 attached to one or more articles 500. FIG. 1 illustrates one wireless tag 600 attached to one article 500, but the communication system 1 may include a plurality of wireless tags 600 attached to a plurality of articles 500. The communication system 1 includes the communication apparatus 10 and the terminal 400 and may not include the one or more articles 500. The communication system 1 is an example of an information processing system.

The communication apparatus 10 is an apparatus that wirelessly communicates with the wireless tag 600. The communication apparatus 10 may be applied to inspection or the like in a warehouse, may also be used in a store, and application examples of the communication apparatus 10 are not limited thereto. The communication apparatus 10 includes a reading apparatus 100, a drive apparatus 200, and an antenna 300.

The reading apparatus 100 is an apparatus that controls the drive apparatus 200 and the antenna 300 to read information from the wireless tag 600. The reading apparatus 100 is also an apparatus that controls the drive apparatus 200 and the antenna 300 to detect tag data on the wireless tag 600. The detection includes meaning of measurement. A configuration example of the reading apparatus 100 will be described later.

The tag data is data detected in time series based on a radio wave of the wireless tag 600 received by the reading apparatus 100. The radio wave of the wireless tag 600 is a radio wave transmitted from the wireless tag 600. The radio wave of the wireless tag 600 may also be referred to as a radio wave from the wireless tag 600. The tag data includes at least one of phase data, Doppler frequency data, and received signal strength indicator (RSSI) data. The phase data is data indicating a phase of the radio wave of the wireless tag 600 received by the reading apparatus 100. The Doppler frequency data is data indicating a frequency of the radio wave of the wireless tag 600 received by the reading apparatus 100. The RSSI data is data indicating an RSSI of the radio wave of the wireless tag 600 received by the reading apparatus 100. The RSSI indicates reception strength. The reception strength is also referred to as radio wave reception strength or reception signal strength.

The drive apparatus 200 is an apparatus that moves the antenna 300. Moving the antenna 300 includes moving a position of the antenna 300. Moving the antenna 300 is an example of moving a relative position of the antenna 300 with respect to the wireless tag 600. The position of the antenna 300 is an example of the relative position of the antenna 300 with respect to the wireless tag 600. A configuration example of the drive apparatus 200 will be described later.

The antenna 300 communicates with the wireless tag 600. The antenna 300 transmits a radio wave. The antenna 300 receives the radio wave of the wireless tag 600. The radio wave of the wireless tag 600 is an example of a response wave from the wireless tag 600 in response to the radio wave transmitted from the antenna 300. The antenna 300 converts the received radio wave into a high-frequency signal and outputs the high-frequency signal to the reading apparatus 100.

The terminal 400 is an apparatus that processes information. The terminal 400 may be a personal computer (PC) or a dedicated apparatus. The terminal 400 is not limited thereto as long as the terminal 400 is an apparatus that processes information. FIG. 1 illustrates one terminal 400, but the communication system 1 may include a plurality of terminals 400. The terminal 400 is an example of an information processing terminal. A configuration example of the terminal 400 will be described later.

The article 500 is a commodity or the like.

The wireless tag 600 is a determination target wireless tag whose positional relationship with respect to the first range is to be determined. For example, the positional relationship of the wireless tag 600 with respect to the first range is that the wireless tag 600 is within the first range, the wireless tag 600 is within a second range, or the wireless tag 600 is within a third range. The first range, the second range, and the third range are different ranges that do not overlap one another. The second range is a range outside the first range and the third range. The third range is a range outside the first range and the second range, and is a range between the first range and the second range. For example, the first range, the second range, and the third range are three-dimensional ranges. The third range is to be described as being in contact with the first range, but is not necessarily in contact with the first range. The third range is to be described as being in contact with the second range, but is not necessarily in contact with the second range. The range includes meaning of a region. Examples of the first range, the second range, and the third range will be described later. The wireless tag 600 may be a wireless tag within the first range, a wireless tag within the second range, or a wireless tag within the third range.

The determination of the positional relationship of the wireless tag 600 with respect to the first range includes determining which range among the first range, the second range, and the third range the wireless tag 600 is within. Determining which range among the first range, the second range, and the third range the wireless tag 600 is within includes determining that the wireless tag 600 is within the first range, the second range, or the third range. The wireless tag 600 being within the first range includes that the wireless tag 600 is present within the first range. The wireless tag 600 being within the first range may include regarding the wireless tag 600 as being within the first range. The wireless tag 600 being within the second range includes that the wireless tag 600 is present within the second range. The wireless tag 600 being within the second range may include regarding the wireless tag 600 as being within the second range. The wireless tag 600 being within the third range includes that the wireless tag 600 is present within the third range. The wireless tag 600 being within the third range may include regarding the wireless tag 600 as being within the third range. The article 500 attached with the wireless tag 600 determined to be within the first range is an article to be treated as a processing target in the communication system 1. The article 500 attached with the wireless tag 600 determined to be within the second range is an article not to be treated as the processing target in the communication system 1.

The wireless tag 600 is an IC tag including an IC chip and an antenna. The wireless tag 600 is typically a radio frequency identification (RFID) tag. The wireless tag 600 may be another IC tag. The wireless tag 600 is a passive type wireless tag that operates using the radio wave transmitted from the antenna 300 as an energy source. By performing backscatter modulation on a non-modulated signal, the wireless tag 600 transmits, through the antenna, a signal including information stored in the IC chip of the wireless tag 600. The information stored in the wireless tag 600 may include identification information that can be uniquely identified. For example, the identification information stored in the wireless tag 600 is an electronic product code (EPC) number. The EPC number includes a unique identification code and a serial number related to the article 500. Hereinafter, the identification information stored in the wireless tag 600 may be abbreviated as “identification information”. The identification information is an example of information on the wireless tag 600.

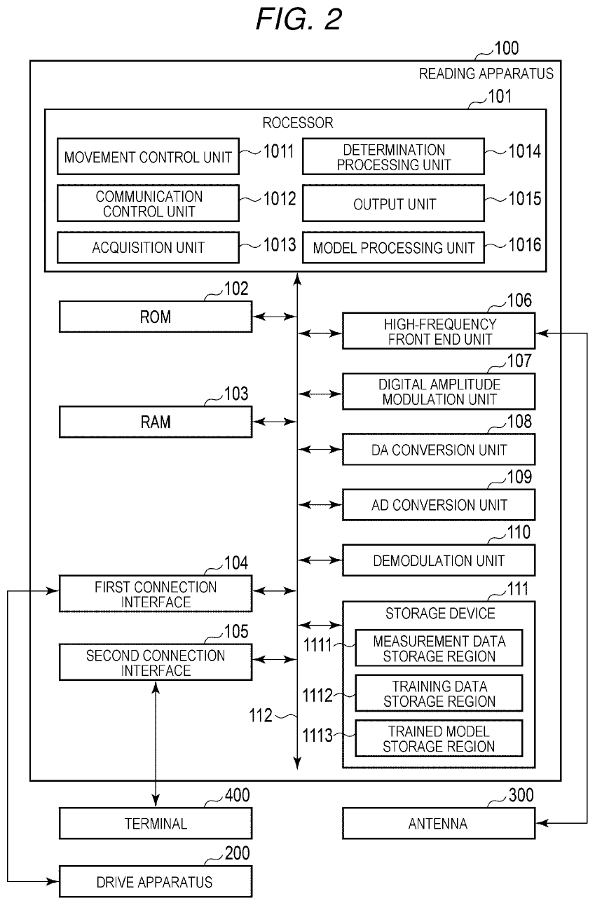

The reading apparatus 100 will be described with reference to FIG. 2.

FIG. 2 illustrates a block diagram of an example of a configuration of the reading apparatus 100.

The reading apparatus 100 includes a processor 101, a read-only memory (ROM) 102, a random-access memory (RAM) 103, a first connection interface 104, a second connection interface 105, a high-frequency front end unit 106, a digital amplitude modulation unit 107, a digital-to-analog (DA) conversion unit 108, an analog-to-digital (AD) conversion unit 109, a demodulation unit 110, and a storage device 111. The units provided in the reading apparatus 100 are connected by a bus 112 or the like.

The processor 101 corresponds to a central part of a computer that performs processing such as calculation and control necessary for an operation of the reading apparatus 100. The processor 101 loads various programs stored in the ROM 102 or the storage device 111 onto the RAM 103. The programs are programs for causing the processor 101 to execute various processes. The processor 101 executes the programs loaded onto the RAM 103 to implement respective units to be described later and execute various processes.

The processor 101 is a central processing unit (CPU), a micro-processing unit (MPU), a system-on-a-chip (SOC), a digital signal processor (DSP), a graphics processing unit (GPU), an application-specific integrated circuit (ASIC), a programmable logic device (PLD), a field-programmable gate array (FPGA), or the like. The processor 101 may be a combination of a plurality of these described above. The processor 101 is an example of a processing circuit.

The ROM 102 corresponds to a main memory apparatus of the computer including the processor 101 as the center. The ROM 102 is a non-volatile memory used exclusively for reading data. The ROM 102 stores the above-described programs. The ROM 102 stores data or various setting values, and the like used when the processor 101 performs various processes.

The RAM 103 corresponds to a main memory apparatus of the computer including the processor 101 as the center. The RAM 103 is a memory used for reading and writing data. The RAM 103 is a work area for storing data used temporarily when the processor 101 performs various processes.

The first connection interface 104 is an interface for the reading apparatus 100 to communicate with the drive apparatus 200.

The second connection interface 105 is an interface for the reading apparatus 100 to communicate with the terminal 400.

The high-frequency front end unit 106 outputs a high-frequency signal to the antenna 300. The high-frequency front end unit 106 receives a high-frequency signal from the antenna 300.

The digital amplitude modulation unit 107 is a circuit that adds data to be transmitted to the wireless tag 600 to a carrier wave to be transmitted to the wireless tag 600.

The DA conversion unit 108 is a circuit that converts a digital signal into an analog signal. The DA conversion unit 108 converts a digital signal modulated by the digital amplitude modulation unit 107 into an analog signal. The DA conversion unit 108 outputs a high-frequency signal to the antenna 300 via the high-frequency front end unit 106.

The AD conversion unit 109 is a circuit that converts an analog signal into a digital signal. The AD conversion unit 109 converts the high-frequency signal received via the high-frequency front end unit 106 from the antenna 300 into a digital signal.

The demodulation unit 110 is a circuit that acquires information based on the radio wave of the wireless tag 600 received by the antenna 300. For example, based on a known technique, the demodulation unit 110 acquires, from the digital signal converted by the AD conversion unit 109, the identification information stored in the wireless tag 600. The demodulation unit 110 is an example of an information acquisition unit that acquires the identification information stored in the wireless tag 600 based on the received radio wave of the wireless tag 600.

The demodulation unit 110 is also a circuit that detects the tag data in time series based on the radio wave of the wireless tag 600 received by the antenna 300. Based on a known technique, the demodulation unit 110 can detect, from the digital signal converted by the AD conversion unit 109, the phase data in time series. Based on a known technique, the demodulation unit 110 can detect, from the digital signal converted by the AD conversion unit 109, the Doppler frequency data in time series. Based on a known technique, the demodulation unit 110 can detect, from the digital signal converted by the AD conversion unit 109, the RSSI data in time series. The demodulation unit 110 is an example of a detection unit that detects the tag data based on the radio wave of the wireless tag 600 received by the antenna 300.

The storage device 111 is an apparatus implemented by a non-volatile memory that stores data, a program, and the like. The storage device 111 is, but is not limited to, a hard disk drive (HDD) or a solid-state drive (SSD). The storage device 111 is an example of a storage unit.

The storage device 111 includes a measurement data storage region 1111.

The measurement data storage region 1111 stores measurement data.

The measurement data includes a tag data set for each wireless tag 600. The tag data set includes a plurality of pieces of tag data at a plurality of positions of the antenna 300. The tag data is detected by the demodulation unit 110 according to movement of the antenna 300 moved by the drive apparatus 200 along one direction. For example, the one direction is a horizontal direction. The tag data set includes a plurality of pieces of position data on the antenna 300. The plurality of pieces of position data on the antenna 300 are data indicating a plurality of positions of the antenna 300. The plurality of positions of the antenna 300 are a plurality of positions based on the movement of the antenna 300. The plurality of pieces of tag data are associated with the plurality of pieces of position data on the antenna 300, respectively. Hereinafter, the plurality of pieces of tag data at the plurality of positions of the antenna 300 may be referred to as a “plurality of pieces of tag data”. Hereinafter, a mode in which the antenna 300 moves along the one direction will be described as an example, but the movement mode of the antenna 300 is not limited thereto. The movement mode of the antenna 300 may be various modes such as rotating and moving along a circumferential direction.

The plurality of positions of the antenna 300 may include positions at a regular interval from a position 0 corresponding to a home position to a position L. It is assumed that a range from the position 0 to the position L is a movement range of the antenna 300 that moves along the one direction. The movement range of the antenna 300 is an example of a movement range of the relative position of the antenna 300 with respect to the wireless tag 600. The position 0 is an example of a first point. The position L is an example of a second point. A value of the regular interval can be set as appropriate. The position L can be set as appropriate. The demodulation unit 110 may detect, depending on the wireless tag 600, the tag data for all of the positions at the regular interval from the position 0 to the position L. The demodulation unit 110 may not detect, depending on the wireless tag 600, the tag data only at a part of the positions at the regular interval from the position 0 to the position L. The measurement data may be updated. A configuration example of the measurement data will be described later.

An example in which the storage device 111 stores the measurement data is described, but the configuration is not limited thereto. The RAM 103 may store the measurement data. In this case, the RAM 103 is an example of the storage unit.

The storage device 111 includes a training data storage region 1112.

The training data storage region 1112 stores training data. The training data is data used for machine learning. The training data includes a plurality of training tag data sets on a plurality of training wireless tags. The training wireless tag is an example of a wireless tag implemented similarly to the wireless tag 600.

The training tag data set is an example of a tag data set including a plurality of pieces of training tag data at a plurality of positions of an antenna. The plurality of positions of the antenna are each an example of a relative position of the antenna with respect to the training wireless tag. The training tag data is an example of tag data on the training wireless tag. The training tag data is detected based on a radio wave of the training wireless tag received by a reading apparatus via the antenna according to movement of the antenna moved by a drive apparatus along one direction. For example, the one direction is the horizontal direction. Moving the antenna is an example of moving the relative position of the antenna with respect to the training wireless tag. The training tag data includes at least one of training phase data, training Doppler frequency data, and training RSSI data. The training tag data set includes a plurality of pieces of position data on the antenna. The plurality of pieces of position data on the antenna are data indicating a plurality of positions of the antenna. The plurality of positions of the antenna are a plurality of positions based on the movement of the antenna. The plurality of pieces of training tag data are associated with the plurality of pieces of position data on the antenna, respectively. A movement mode of the antenna is not limited to a mode in which the antenna moves along the one direction. The movement mode of the antenna may be various modes such as rotating and moving along a circumferential direction.

The training wireless tag may be a wireless tag in the first range, a wireless tag in the second range, or a wireless tag in the third range. The plurality of training tag data sets related to the plurality of training wireless tags are examples of a plurality of pieces of training tag data on a plurality of training wireless tags.

The reading apparatus may be the same reading apparatus as the reading apparatus 100 or may be a reading apparatus different from the reading apparatus 100. The antenna may be the same antenna as the antenna 300 or may be an antenna different from the antenna 300. The drive apparatus may be the same drive apparatus as the drive apparatus 200 or may be a drive apparatus different from the drive apparatus 200.

The training data includes a plurality of pieces of ground truth data. The plurality of pieces of ground truth data are a plurality of pieces of data indicating a positional relationship of the plurality of training wireless tags with respect to the first range. The ground truth data is data indicating the positional relationship of the training wireless tag with respect to the first range for each training wireless tag. The positional relationship of the training wireless tag with respect to the first range is that the training wireless tag is within the first range, the training wireless tag is within the second range, or the training wireless tag is within the third range. The training wireless tag being within the first range includes that the training wireless tag is present within the first range. The training wireless tag being within the first range may include regarding the training wireless tag as being within the first range. The training wireless tag being within the second range includes that the training wireless tag is present within the second range. The training wireless tag being within the second range may include regarding the training wireless tag as being within the second range. The training wireless tag being within the third range includes that the training wireless tag is present within the third range. The training wireless tag being within the third range may include regarding the training wireless tag as being within the third range. The ground truth data for the training wireless tag within the first range is data indicating that the training wireless tag is within the first range. The ground truth data for the training wireless tag within the second range is data indicating that the training wireless tag is within the second range. The ground truth data for the training wireless tag within the third range is data indicating that the training wireless tag is within the third range. The ground truth data is data input by a user. The training data may be updated. The storage device 111 includes a trained model storage region 1113.

The trained model storage region 1113 stores a trained model. The trained model is a model generated by the machine learning based on the training data. The expression “generation” includes not only a newly created mode but also an updated mode.

The trained model is used to determine the positional relationship of the wireless tag 600 with respect to the first range. The trained model outputs determination output data for each wireless tag 600 based on input of determination input data. The determination input data includes a plurality of pieces of tag data at a plurality of positions of the antenna 300. The determination output data is data indicating the positional relationship of the wireless tag 600 with respect to the first range. For example, the determination output data is data indicating that the wireless tag 600 is within the first range, data indicating that the wireless tag 600 is within the second range, or data indicating that the wireless tag 600 is within the third range.

The bus 112 includes a control bus, an address bus, a data bus, and the like. The bus 112 transmits a signal to be exchanged between the units of the reading apparatus 100.

The hardware configuration of the reading apparatus 100 is not limited to the above-described configuration. In the reading apparatus 100, the above-described constituent elements may be appropriately omitted and changed, and a new constituent element may be added thereto.

Each unit implemented by the processor 101 will be described.

The processor 101 implements a movement control unit 1011, a communication control unit 1012, an acquisition unit 1013, a determination processing unit 1014, an output unit 1015, and a model processing unit 1016. Each unit implemented by the processor 101 can also be referred to as each function. Each unit implemented by the processor 101 may also be implemented by a control unit including the processor 101, the ROM 102, and the RAM 103.

The movement control unit 1011 controls the movement of the antenna 300 along the one direction by controlling the drive apparatus 200.

The communication control unit 1012 controls start and end of transmission of the radio wave from the antenna 300.

The acquisition unit 1013 acquires the tag data for each wireless tag 600 based on the radio wave of the wireless tag 600 received by the antenna 300.

The determination processing unit 1014 determines, based on a plurality of pieces of tag data on the wireless tag 600, which range among the first range, the second range, and the third range the wireless tag 600 is within.

If the determination processing unit 1014 determines that the wireless tag 600 is within the first range or the second range, the output unit 1015 outputs a determination result to the terminal 400. The determination result includes data indicating the positional relationship of the wireless tag 600 with respect to the first range determined by the determination processing unit 1014. For example, the determination result includes data indicating that the wireless tag 600 is within the first range or data indicating that the wireless tag 600 is within the second range. The determination result is associated with the identification information of the wireless tag 600 determined to be within the first range or the second range.

If the determination processing unit 1014 determines that the wireless tag 600 is within the third range, the output unit 1015 outputs input request information to the terminal 400. The input request information is information on the wireless tag 600 determined to be within the third range. The input request information is information on the wireless tag 600 for prompting the user to input which range of the first range and the second range the wireless tag 600 is within. The inputting which range of the first range and the second range the wireless tag 600 is within includes inputting which range of the first range and the second range the wireless tag 600 is to be treated as being within. The inputting which range of the first range and the second range the wireless tag 600 is within is an example of inputting a range including the wireless tag 600. The input request information may include an instruction to display an input image to be described later. The input request information may include the identification information of the wireless tag 600 determined to be within the third range. The input request information may include image data of the input image.

The model processing unit 1016 generates the trained model.

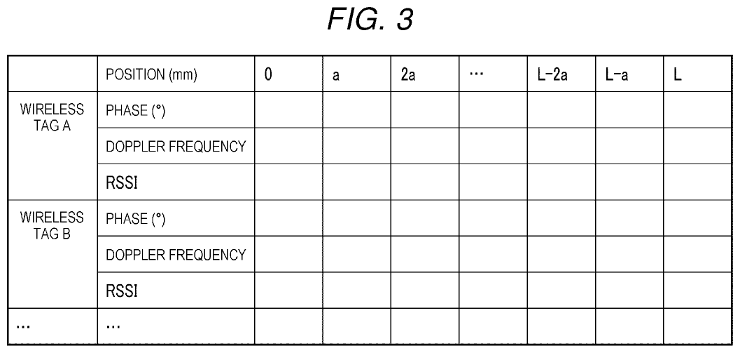

FIG. 3 illustrates an example of a data structure of the measurement data.

The measurement data includes a tag data set for each wireless tag 600. The tag data set includes a plurality of pieces of tag data at a plurality of positions of the antenna 300. The tag data set includes tag data associated with a part or all of positions at a regular interval a between the position 0 and the position L. The tag data set may include tag data associated with each position different from the positions at the regular interval a between the position 0 and the position L.

The tag data set may include a plurality of pieces of phase data at a plurality of positions of the antenna 300. A phase value changes as the position of the antenna 300 changes. This is because a distance between the antenna 300 and the wireless tag 600 changes as the antenna 300 moves. Since the phase value depends on the distance between the antenna 300 and the wireless tag 600, distribution of the plurality of pieces of phase data differs depending on a position of the wireless tag 600.

The tag data set may include a plurality of pieces of Doppler frequency data at a plurality of positions of the antenna 300. A Doppler frequency value changes as the position of the antenna 300 changes. This is because the Doppler frequency value is different between a case where the antenna 300 approaches the wireless tag 600 and a case where the antenna 300 is away from the wireless tag 600. Distribution of the plurality of pieces of Doppler frequency data differs depending on the position of the wireless tag 600.

The tag data set may include a plurality of pieces of RSSI data at a plurality of positions of the antenna 300. An RSSI value changes as the position of the antenna 300 changes. This is because the distance between the antenna 300 and the wireless tag 600 changes as the antenna 300 moves. Since the RSSI value depends on the distance between the antenna 300 and the wireless tag 600, distribution of the plurality of pieces of RSSI data differs depending on the position of the wireless tag 600.

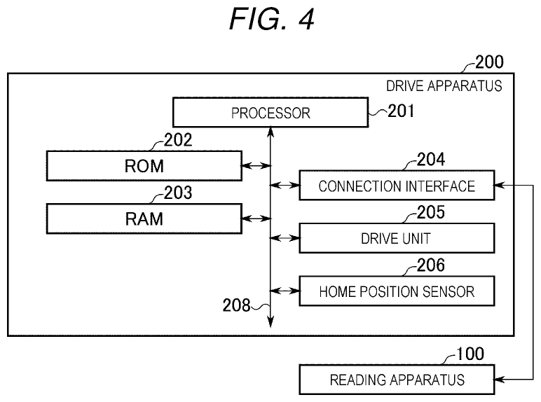

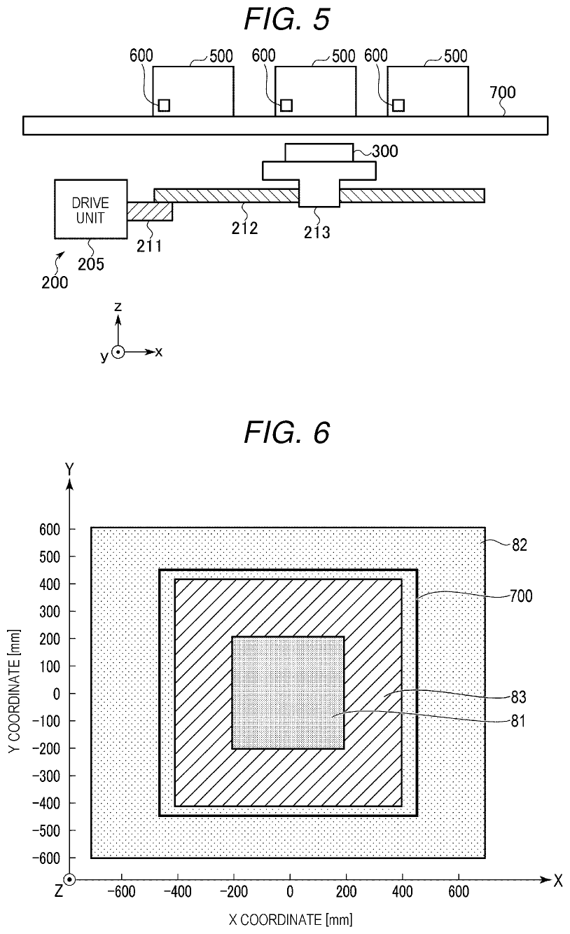

The drive apparatus 200 will be described with reference to FIGS. 4 and 5.

FIG. 4 illustrates a block diagram of an example of a configuration of the drive apparatus 200.

The drive apparatus 200 includes a processor 201, a ROM 202, a RAM 203, a connection interface 204, a drive unit 205, and a home position sensor 206. The units provided in the drive apparatus 200 are connected by a bus 208 or the like.

The processor 201 corresponds to a central part of a computer that performs processing such as calculation and control necessary for an operation of the drive apparatus 200. The processor 201 loads various programs stored in the ROM 202 or the like onto the RAM 203. The programs are programs for causing the processor 201 to execute various processes. The processor 201 executes the programs loaded onto the RAM 203 to execute various processes. The processor 201 is a CPU, MPU, SOC, DSP, GPU, ASIC, PLD, FPGA, or the like. The processor 201 may also be a combination of a plurality of these described above. The processor 201 is an example of a processing circuit.

The ROM 202 corresponds to a main memory apparatus of the computer including the processor 201 as the center. The ROM 202 is a non-volatile memory used exclusively for reading data. The ROM 202 stores the above-described programs. The ROM 202 stores data or various setting values, and the like used when the processor 201 performs various processes.

The RAM 203 corresponds to a main memory apparatus of the computer including the processor 201 as the center. The RAM 203 is a memory used for reading and writing data. The RAM 203 is a work area for storing data used temporarily when the processor 201 performs various processes.

The connection interface 204 is an interface for the drive apparatus 200 to communicate with the reading apparatus 100.

The drive unit 205 moves the antenna 300. For example, the drive unit 205 is a stepping motor.

The home position sensor 206 is a sensor that detects whether the antenna 300 is at a start point. If the drive unit 205 moves the antenna 300 from the first point to the second point, the start point is the first point, and an end point is the second point. If the drive unit 205 moves the antenna 300 from the second point to the first point, the start point is the second point, and the end point is the first point.

The bus 208 includes a control bus, an address bus, a data bus, and the like. The bus 208 transmits a signal to be exchanged between the units of the drive apparatus 200.

FIG. 5 illustrates a schematic diagram for explaining the drive apparatus 200.

The drive apparatus 200 includes a rotation shaft 211, a rail 212, and a moving stage 213.

As illustrated in FIG. 5, the drive apparatus 200 and the antenna 300 are disposed below a counter table 700. The counter table 700 is a table having a horizontal surface on which the articles 500 each attached with the wireless tag 600 are placed. The counter table 700 is an example of a placement portion. The counter table 700 may be provided in the communication system 1 or the communication apparatus 10.

The rotation shaft 211 transmits a driving force of the drive unit 205. Screw grooves are formed in the rotation shaft 211 and the rail 212. The screw grooves are connected to face each other. Therefore, when the drive unit 205 rotationally drives, the rotation shaft 211 rotates and the rail 212 rotates.

The rail 212 extends along the one direction. The moving stage 213 on which the antenna 300 is placed is attached to the rail 212.

The moving stage 213 includes a ball screw nut and moves in the one direction along the rail 212 when the rail 212 is rotated by the ball screw nut. That is, the moving stage 213 moves in the horizontal direction along an x-axis illustrated in FIG. 5. The moving stage 213 reciprocates along the one direction according to a rotation direction of the rail 212. Thus, the drive apparatus 200 reciprocates the antenna 300 in the one horizontal direction along the x-axis along the rail 212.

The hardware configuration of the drive apparatus 200 is not limited to the above-described configuration. In the drive apparatus 200, the above-described constituent elements may be appropriately omitted and changed, and a new constituent element may be added thereto. For example, the movement mode of the antenna 300 may be a mode in which the antenna 300 rotates and moves along the circumferential direction instead of the mode in which the antenna 300 moves along the one horizontal direction.

The first range, the second range, and the third range will be described.

FIG. 6 illustrates a schematic diagram for explaining a first range 81, a second range 82, and a third range 83, and is a plan view of the counter table 700 as viewed from above. The horizontal surface of the counter table 700 is along an xy plane.

The first range 81 is a range set in a central portion of the horizontal surface of the counter table 700. The second range 82 is a range set in an outer peripheral portion of the horizontal surface of the counter table 700 and outside the counter table 700 in the horizontal direction. The second range 82 surrounds the first range 81.

Setting of the first range 81 and the second range 82 is not limited thereto. The first range 81 may be a range set in the central portion of the horizontal surface of the counter table 700. The second range 82 may be a range set in the outer peripheral portion of the horizontal surface of the counter table 700. The first range 81 may be a range set over the entire horizontal surface of the counter table 700. The second range 82 may be a range set outside the counter table 700 in the horizontal direction.

The third range 83 surrounds the first range 81 on the horizontal surface of the counter table 700. The third range 83 is a range between the first range 81 and the second range 82 in the horizontal direction on the horizontal surface of the counter table 700.

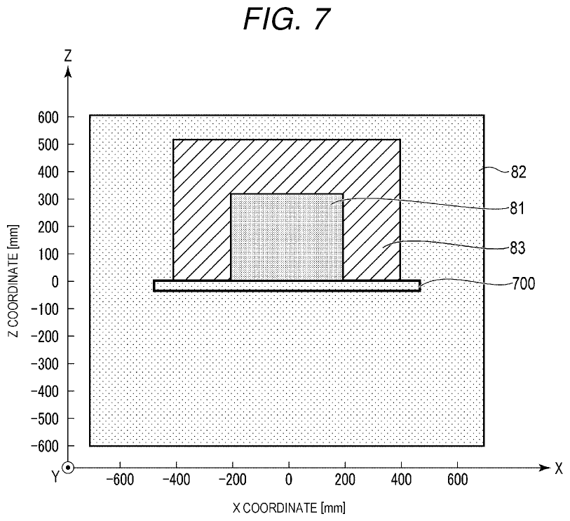

FIG. 7 illustrates a schematic diagram for explaining the first range 81, the second range 82, and the third range 83, and is a side view of the counter table 700 as viewed from a side.

The third range 83 surrounds the first range 81 on the counter table 700. The third range 83 is a range between the first range 81 and the second range 82 in a vertical direction along a z-axis.

A positional relationship between the first range 81 and the movement range of the antenna 300 will be described.

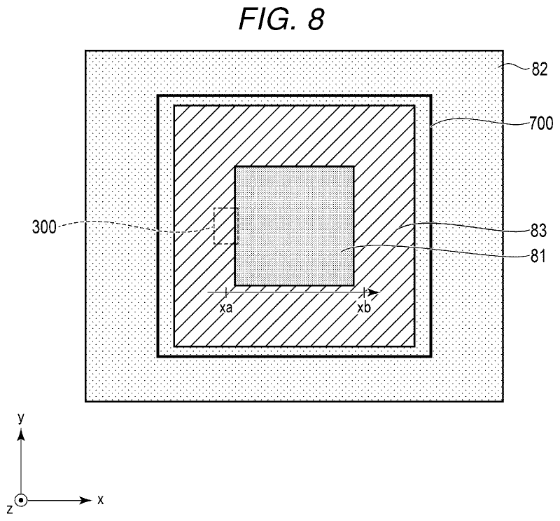

FIG. 8 illustrates a schematic diagram for explaining the positional relationship between the first range 81 and the movement range of the antenna 300.

As will be exemplified below, the first range 81 faces a part or all of the movement range of the antenna 300. The horizontal direction along the x-axis is a moving direction of the antenna 300. The moving direction of the antenna 300 is an example of a moving direction of the relative position of the antenna 300 with respect to the wireless tag 600. The vertical direction along the z-axis is a direction orthogonal to the moving direction of the antenna 300. The movement range of the antenna 300 is between a first point xa and a second point xb along the x-axis. The first point xa is a position that does not face the first range 81 along the z-axis, which is a position outside one end of the first range 81 along the x-axis. The second point xb is a position that does not face the first range 81 along the z-axis, which is a position outside the other end of the first range 81 along the x-axis. The first range 81 faces a part of the movement range of the antenna 300 along the z-axis. One of the first point xa and the second point xb may be a position that does not face the first range 81 along the z-axis, and the other may be a position facing the first range 81 along the z-axis. In this case, the first range 81 faces a part of the movement range of the antenna 300 in the direction along the z-axis. The first point xa and the second point xb may both be positions facing the first range 81 along the z-axis. In this case, the first range 81 faces the entire movement range of the antenna 300 along the z-axis.

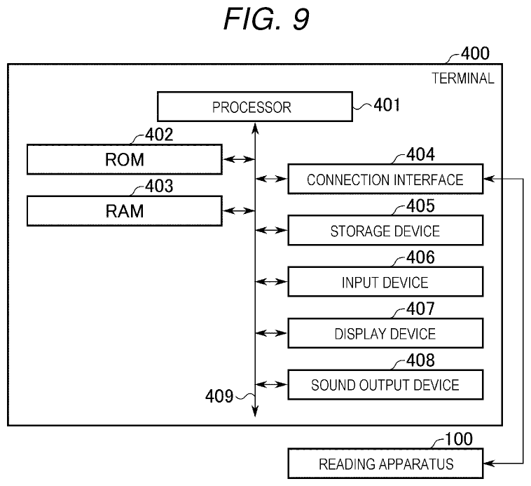

FIG. 9 illustrates a block diagram of an example of a configuration of the terminal 400.

The terminal 400 includes a processor 401, a ROM 402, a RAM 403, a connection interface 404, a storage device 405, an input device 406, a display device 407, and a sound output device 408. The units provided in the terminal 400 are connected by a bus 409 or the like. A configuration of the processor 401 may be the same as the configuration of the processor 101. A configuration of the ROM 402 may be the same as the configuration of the ROM 102. A configuration of the RAM 403 may be the same as the configuration of the RAM 103. The connection interface 404 is an interface for the terminal 400 to communicate with the reading apparatus 100. A configuration of the storage device 405 may be the same as the configuration of the storage device 111.

The input device 406 is a device that enables an instruction to be input based on a user operation. The input device 406 may include a pressable button. The input device 406 may include a touch panel integrated with the display device 407.

The display device 407 is a device that can display various images. The display device 407 is, but is not limited to, a liquid crystal display or an organic electroluminescence (EL) display.

The sound output device 408 is a device that can output sound. The sound output device 408 is, but is not limited to, a speaker.

### Operation Example

Processing in the communication system 1 will be described.

A processing procedure to be described below is merely an example, and each process may be changed if possible. Acts in the processing procedure described below can be omitted or replaced, or an act can be added thereto as appropriate according to embodiments.

A determination process performed by the processor 101 of the reading apparatus 100 will be described. The determination process is a process for the wireless tag 600 of determining the positional relationship of the wireless tag 600 with respect to the first range.

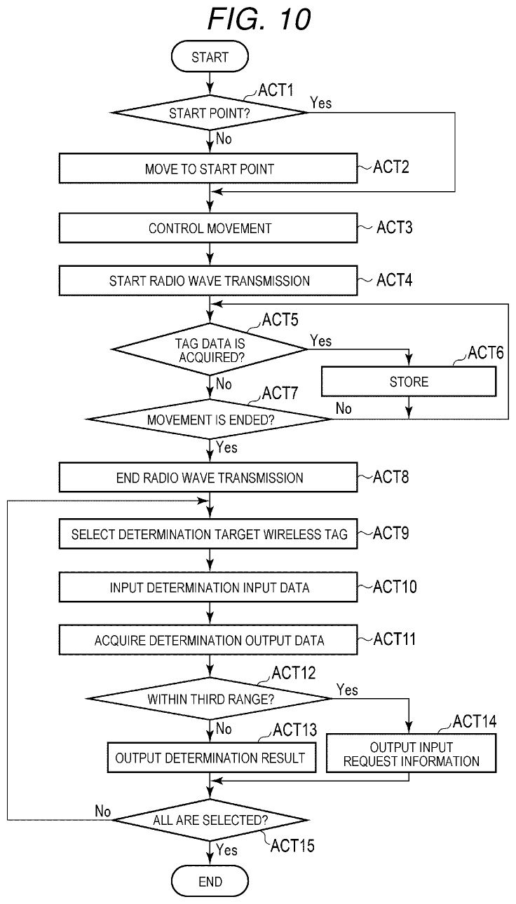

FIG. 10 illustrates a flowchart of an example of the determination process performed by the processor 101 of the reading apparatus 100.

For example, one or more wireless tags 600 attached to one or more articles 500 required to be treated as processing targets in the communication system 1 are placed on the counter table 700. The one or more articles 500 required to be treated as the processing targets may be directly placed on the counter table 700 or may be placed on the counter table 700 in a state of being put in a container. For example, the container is, but is not limited to, a basket. All of the one or more wireless tags 600 may be placed within the first range. At least one of the one or more wireless tags 600 may protrude from the first range and be placed within the third range. An article 500 that is not required to be treated as a processing target in the communication system 1 may be present in the second range.

The processor 101 of the reading apparatus 100 may start the determination process based on acquisition of a determination process start instruction input by the user through the terminal 400.

Here, it is assumed that the start point is the first point, and the end point is the second point. Therefore, the drive unit 205 moves the antenna 300 from the first point to the second point in the one direction.

The movement control unit 1011 determines whether the antenna 300 is located at the start point (ACT 1). If the antenna 300 is not located at the start point (ACT 1, NO), the process transitions from ACT 1 to ACT 2. If the antenna 300 is located at the start point (ACT 1, YES), the process transitions from ACT 1 to ACT 3.

The movement control unit 1011 controls the antenna 300 to move to the start point (ACT 2). In ACT 2, for example, the movement control unit 1011 transmits, to the drive apparatus 200, a move-to-start-point instruction. The move-to-start-point instruction is an instruction to move the antenna 300 to the start point. The processor 201 of the drive apparatus 200 receives, from the reading apparatus 100, the move-to-start-point instruction. The processor 201 controls the drive unit 205 to move the antenna 300 to the start point based on the move-to-start-point instruction. The drive unit 205 moves the antenna 300 to the start point under control of the processor 201.

The movement control unit 1011 controls the movement of the antenna 300 (ACT 3). In ACT 3, for example, the movement control unit 1011 controls the antenna 300 to move from the start point to the end point along the one direction. The movement control unit 1011 transmits, to the drive apparatus 200, a move-to-end-point instruction. The move-to-end-point instruction is an instruction to move the antenna 300 from the start point to the end point. The processor 201 of the drive apparatus 200 receives, from the reading apparatus 100, the move-to-end-point instruction. The processor 201 controls the drive unit 205 to move the antenna 300 from the start point to the end point in the one direction based on the move-to-end-point instruction. The drive unit 205 moves the antenna 300 from the start point to the end point in the one direction under control of the processor 201.

The communication control unit 1012 controls start of radio wave transmission from the antenna 300 (ACT 4). In ACT 4, for example, the communication control unit 1012 controls the start of the radio wave transmission from the antenna 300 based on start of the movement of the antenna 300 from the start point. The communication control unit 1012 may control the start of the radio wave transmission from the antenna 300 based on a movement start notification from the drive apparatus 200. The movement start notification may indicate that the movement of the antenna 300 starts from the start point. The antenna 300 starts radio wave transmission for reading the identification information stored in the wireless tag 600.

The acquisition unit 1013 acquires tag data for each wireless tag 600 (ACT 5). In ACT 5, for example, the acquisition unit 1013 acquires the tag data detected by the demodulation unit 110 for each wireless tag 600. If the acquisition unit 1013 acquires the tag data (ACT 5, YES), the process transitions from ACT 5 to ACT 6. If the acquisition unit 1013 does not acquire the tag data (ACT 5, NO), the process transitions from ACT 5 to ACT 7.

Based on the acquisition of the tag data, the acquisition unit 1013 stores the tag data as data constituting the measurement data in the measurement data storage region 1111 (ACT 6).

The communication control unit 1012 determines whether the movement of the antenna 300 ends (ACT 7). In ACT 7, for example, the communication control unit 1012 determines whether the movement of the antenna 300 from the start point to the end point ends. The communication control unit 1012 may determine that the movement of the antenna 300 ends based on a movement end notification from the drive apparatus 200. The movement end notification may indicate that the movement of the antenna 300 ends since the end point is reached. If the movement of the antenna 300 ends (ACT 7, YES), the process transitions from ACT 7 to ACT 8. If the movement of the antenna 300 does not end (ACT 7, NO), the process transitions from ACT 7 to ACT 5.

The acquisition unit 1013 repeats the processes of ACT 5 and ACT 6 after the start of the movement of the antenna 300 at the start point until the movement is ended at the end point.

In ACT 5, the acquisition unit 1013 acquires, for each wireless tag 600, a plurality of pieces of tag data detected by the demodulation unit 110 at a plurality of positions of the antenna 300. For example, the acquisition unit 1013 can acquire, for each wireless tag 600, a plurality of pieces of phase data, Doppler frequency data, or RSSI data detected by the demodulation unit 110 at the plurality of positions of the antenna 300.

In ACT 6, for each wireless tag 600, the acquisition unit 1013 stores, in the measurement data storage region 1111, the plurality of pieces of tag data at the plurality of positions of the antenna 300. For example, for each wireless tag 600, the acquisition unit 1013 can store, in the measurement data storage region 1111, the plurality of pieces of phase data, Doppler frequency data, or RSSI data at the plurality of positions of the antenna 300.

The communication control unit 1012 controls end of the radio wave transmission from the antenna 300 (ACT 8). In ACT 8, for example, the communication control unit 1012 controls the end of the radio wave transmission from the antenna 300 based on the end of the movement of the antenna 300. The end of the movement of the antenna 300 is the end of the movement of the antenna 300 from the start point to the end point along the one direction. The antenna 300 ends the radio wave transmission for reading the identification information stored in the wireless tag 600.

The determination processing unit 1014 selects one determination target wireless tag (ACT 9). In ACT 9, for example, the determination processing unit 1014 selects, as the determination target wireless tag, one wireless tag 600 from one or more wireless tags 600 whose tag data set is stored in the measurement data storage region 1111. The determination processing unit 1014 performs processes of ACT 10 to ACT 14 on the wireless tag 600 selected as the determination target wireless tag. The determination processing unit 1014 determines, by the processes of ACT 10 and ACT 11, the positional relationship of the wireless tag 600 with respect to the first range based on the plurality of pieces of tag data related to the wireless tag 600 selected as the determination target wireless tag. Here, the determination processing unit 1014 determines which range among the first range, the second range, and the third range the wireless tag 600 is within.

The determination processing unit 1014 inputs the determination input data to the trained model (ACT 10). In ACT 10, for example, the determination processing unit 1014 acquires, based on the measurement data stored in the measurement data storage region 1111, the determination input data for the wireless tag 600 selected as the determination target wireless tag. The determination processing unit 1014 inputs the acquired determination input data to the trained model.

The determination processing unit 1014 acquires the determination output data output from the trained model based on the input of the determination input data to the trained model (ACT 11). The acquisition of the determination output data is an example of determining the positional relationship of the wireless tag 600 with respect to the first range based on the determination output data. The determination of the positional relationship of the wireless tag 600 with respect to the first range based on the determination output data is an example of determining the positional relationship of the wireless tag 600 with respect to the first range based on the plurality of pieces of tag data on the wireless tag 600.

If the determination processing unit 1014 determines that the wireless tag 600 is within the first range or the second range (ACT 12, NO), the process transitions from ACT 12 to ACT 13. If the determination processing unit 1014 determines that the wireless tag 600 is within the third range (ACT 12, YES), the process transitions from ACT 12 to ACT 14.

The output unit 1015 outputs a determination result for the wireless tag 600 to the terminal 400 via the second connection interface 105 (ACT 13). The output unit 1015 outputs, to the terminal 400 via the second connection interface 105, the identification information stored in the wireless tag 600 read by the reading apparatus 100. The determination result is associated with the identification information.

The terminal 400 may change whether to treat the article 500 attached with the wireless tag 600 as a processing target according to the determination result for the wireless tag 600. When the determination processing unit 1014 determines that the wireless tag 600 is within the first range, the terminal 400 treats the article 500 attached with the wireless tag 600 as the processing target. Treating the article 500 attached with the wireless tag 600 as the processing target includes treating the wireless tag 600 or the identification information stored in the wireless tag 600 as the processing target. When the determination processing unit 1014 determines that the wireless tag 600 is within the second range, the terminal 400 does not treat the article 500 attached with the wireless tag 600 as the processing target. Not treating the article 500 attached with the wireless tag 600 as the processing target includes not treating the wireless tag 600 or the identification information stored in the wireless tag 600 as the processing target.

The output unit 1015 outputs the input request information to the terminal 400 via the second connection interface 105 (ACT 14). The output unit 1015 outputs, to the terminal 400 via the second connection interface 105, the identification information stored in the wireless tag 600 read by the reading apparatus 100. The input request information is associated with the identification information.

The terminal 400 can display, based on the input request information, the input image to be described later on the display device 407. The user can input that the wireless tag 600 is within the first range or the second range on the input image. Inputting that the wireless tag 600 is within the first range includes inputting that the wireless tag 600 is treated as being within the first range. Inputting that the wireless tag 600 is within the second range includes inputting that the wireless tag 600 is treated as being within the second range. The terminal 400 may change whether to treat the article 500 attached with the wireless tag 600 as the processing target based on the input by the user with respect to the wireless tag 600 determined to be within the third range by the determination processing unit 1014. If the user inputs that the wireless tag 600 is within the first range, the terminal 400 treats the article 500 attached with the wireless tag 600 as the processing target. If the user inputs that the wireless tag 600 is within the second range, the terminal 400 does not treat the article 500 attached with the wireless tag 600 as the processing target.

When the reading apparatus 100 includes a display device, the output unit 1015 may not output the input request information to the terminal 400. In this example, the output unit 1015 outputs the input request information to the display device in order to display the input image on the display device. The display device of the reading apparatus 100 displays the input image based on the input request information.

The determination processing unit 1014 determines whether all the wireless tags 600 are selected as the determination target wireless tag (ACT 15). In ACT 15, for example, the determination processing unit 1014 determines whether all the wireless tags 600 whose tag data set is stored in the measurement data storage region 1111 are selected.

If the determination processing unit 1014 selects all the wireless tags 600 as the determination target wireless tag (ACT 15, YES), the process ends. If the determination processing unit 1014 does not select all the wireless tags 600 as the determination target wireless tag (ACT 15, NO), the process transitions from ACT 15 to ACT 9.

Thus, the reading apparatus 100 does not determine that the wireless tag 600 attached to the article 500 required to be treated as the processing target in the communication system 1 is within the second range. The reading apparatus 100 does not determine that the wireless tag 600 attached to the article 500, which is present in the second range and that is not required to be treated as the processing target in the communication system 1, is within the first range. For example, the reading apparatus 100 can determine that the wireless tag 600 on an edge of the first range or the second range is within the third range instead of determining that the wireless tag 600 is within the first range or the second range.

A plurality of pieces of phase data on the wireless tag 600 corresponding to the position of the wireless tag 600 will be described.

FIG. 11 illustrates the position of the wireless tag 600.

An area (A) is within the first range 81. In the area (A), five wireless tags 600 are arranged at different positions along the x-axis. An area (B) is within the second range 82. The area (B) faces the area (A) along the y-axis. In the area (B), five wireless tags 600 are arranged at different positions along the x-axis. An area (C) is within the second range 82. The area (C) faces the area (A) along the x-axis. In the area (C), five wireless tags 600 are arranged at different positions along the x-axis.

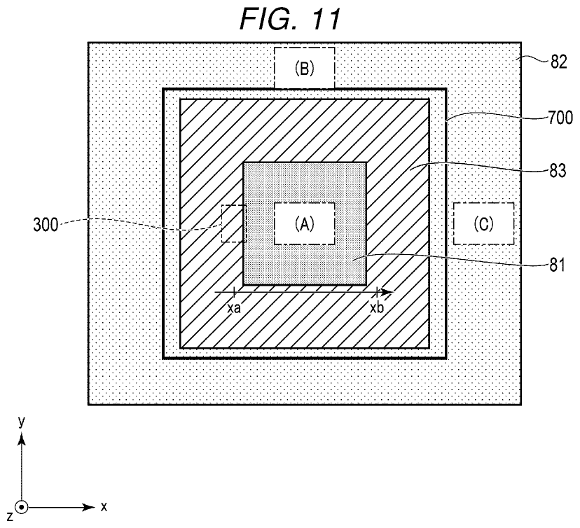

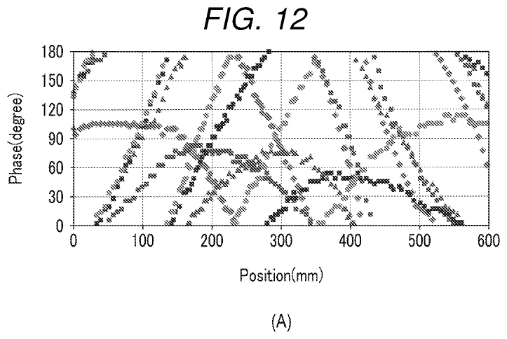

FIG. 12 illustrates an example of a plurality of pieces of phase data on the five wireless tags 600 placed in the area (A) within the first range 81.

A horizontal axis indicates the position of the antenna 300 along the x-axis. A vertical axis indicates a phase value. A graph indicates a plurality of phase values between the first point (0 mm) and the second point (600 mm) for each of the five wireless tags 600. Focusing on any one wireless tag 600 among the five wireless tags 600 placed in the area (A), the phase value changes as the position of the antenna 300 changes. Focusing on any position, even though the antenna 300 is at the same position, the phase values on the five wireless tags 600 placed in the area (A) are different.

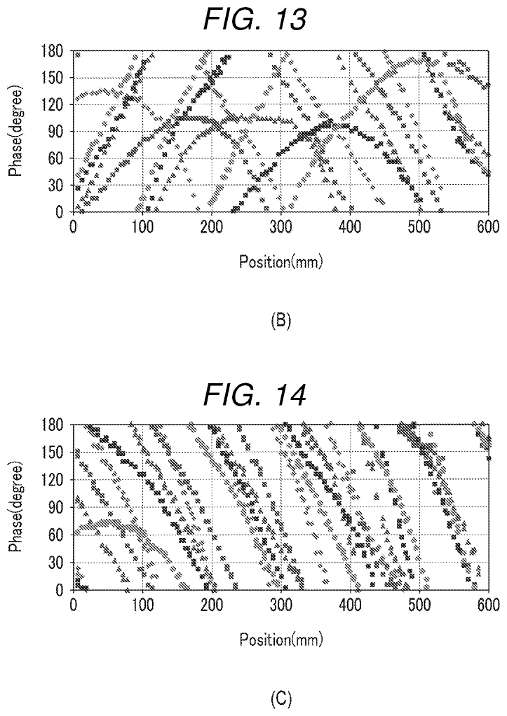

FIG. 13 illustrates an example of a plurality of pieces of phase data on the wireless tags 600 placed in the area (B) within the second range 82.

A horizontal axis indicates the position of the antenna 300 along the x-axis. A vertical axis indicates the phase value. A graph indicates a plurality of phase values between the first point (0 mm) and the second point (600 mm) for each of the five wireless tags 600. Focusing on any one wireless tag 600 among the five wireless tags 600 placed in the area (B), the phase value changes as the position of the antenna 300 changes. Focusing on any position, even though the antenna 300 is at the same position, the phase values on the five wireless tags 600 placed in the area (B) are different.

FIG. 14 illustrates another example of the plurality of pieces of phase data on the wireless tags 600 placed in the area (C) within the second range 82.

A horizontal axis indicates the position of the antenna 300 along the x-axis. A vertical axis indicates the phase value. A graph indicates a plurality of phase values between the first point (0 mm) and the second point (600 mm) for each of the five wireless tags 600. Focusing on any one wireless tag 600 among the five wireless tags 600 placed in the area (C), the phase value changes as the position of the antenna 300 changes. Focusing on any position, even though the antenna 300 is at the same position, the phase values on the five wireless tags 600 placed in the area (C) are different.

As illustrated in FIGS. 12 to 14, distribution of the plurality of pieces of phase data on the wireless tags 600 differs within the first range 81 and within the second range 82. The distribution of the plurality of pieces of phase data on the wireless tags 600 differs depending on the positions of the wireless tags 600 within the first range 81. The distribution of the plurality of pieces of phase data on the wireless tags 600 differs depending on the positions of the wireless tags 600 within the second range 82.

For example, the wireless tag 600 attached to the article 500 required to be treated as the processing target may protrude from the first range 81 to the third range 83. Here, it is assumed that the wireless tag 600 protrudes from the first range 81 to the third range 83 along the y-axis. A distribution of a plurality of pieces of phase data on such a wireless tag 600 may be similar to the distribution in the second range 82 illustrated in FIG. 13 rather than the distribution in the first range 81 illustrated in FIG. 12. When the determination processing unit 1014 determines that a range of the wireless tag 600 is within the first range 81 or the second range 82, the determination processing unit 1014 may determine that the wireless tag 600 is within the second range 82. In order to avoid such determination, the determination processing unit 1014 uses the third range 83 in addition to the first range 81 and the second range 82. By determining that the wireless tag 600 is within the third range 83, the determination processing unit 1014 can avoid erroneously determining that the wireless tag 600 is within the second range 82.

An input image display process performed by the processor 401 of the terminal 400 will be described.

The input image display process is a process of displaying the input image on the display device 407 of the terminal 400. The input image is an image for prompting the user to input that the wireless tag 600 is within the first range or the second range. The user can input that the wireless tag 600 is within the first range or the second range via the input device 406.

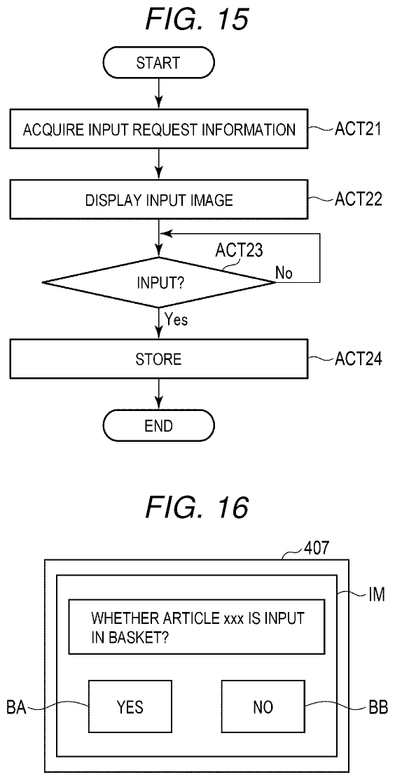

FIG. 15 illustrates a flowchart of an example of the input image display process performed by the processor 401 of the terminal 400.

The processor 401 acquires the input request information from the reading apparatus 100 via the connection interface 404 (ACT 21).

The processor 401 displays the input image on the display device 407 based on the input request information (ACT 22). In ACT 22, for example, based on the identification information associated with the input request information, the processor 401 acquires information on the article 500 attached with the wireless tag 600 from a server. The information on the article 500 is information specific to the article 500. For example, the information specific to the article 500 includes, but is not limited to, information indicating a name of the article 500. For each piece of identification information, the server may store the information on the article 500 associated with the identification information. The processor 401 displays, on the display device 407, the input image including the acquired information on the article 500 in a recognizable manner.

The processor 401 detects input via the input device 406 based on a user operation (ACT 23). When there is no input via the input device 406 (ACT 23, NO), the processor 401 continues the process of ACT 23. When there is input via the input device 406 (ACT 23, YES), the process transitions from ACT 23 to ACT 24.

The processor 401 stores an input result in the storage device 405 (ACT 24). The input result includes data input by the user indicating that the wireless tag 600 is within the first range or the second range. The input result is associated with the identification information. The processor 401 may store the input result in the RAM 403.

FIG. 16 illustrates an example of an input image IM displayed on the display device 407 of the terminal 400.

The input image IM includes a message for prompting the user to input that the wireless tag 600 is within the first range or the second range. The message includes the name of the article 500.

The input image IM includes a button BA for selecting that the article 500 is within the first range. The article 500 being within the first range is an example of the wireless tag 600 attached to the article 500 being within the first range. The button BA is an example of a key for inputting that the article 500 is within the first range.

The input image IM includes a button BB for selecting that the article 500 is within the second range. The article 500 being within the second range is an example of the wireless tag 600 attached to the article 500 being within the second range. The button BB is an example of a key for inputting that the article 500 is within the second range.

A trained model generation process performed by the processor 101 of the reading apparatus 100 will be described. The trained model generation process is a process of generating the trained model.

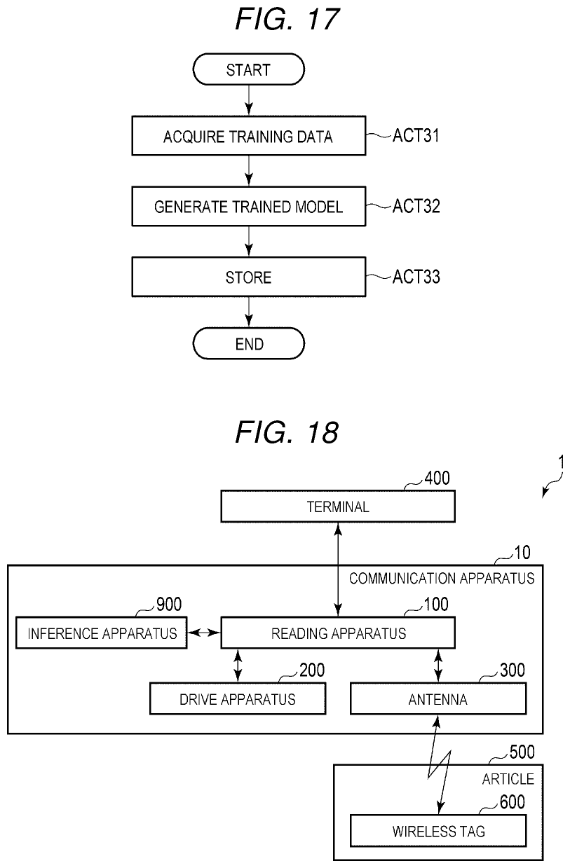

FIG. 17 illustrates a flowchart of an example of the trained model generation process performed by the processor 101 of the reading apparatus 100.

The model processing unit 1016 may start the trained model generation process at any timing to newly create the trained model. The model processing unit 1016 may start the trained model generation process at any timing to update the trained model.

The model processing unit 1016 acquires the training data (ACT 31). In ACT 31, for example, the model processing unit 1016 acquires the training data from the training data storage region 1112.

The model processing unit 1016 generates the trained model by machine learning based on the training data (ACT 32). In ACT 32, for example, the model processing unit 1016 learns the training data by machine learning. The model processing unit 1016 estimates a relationship between a plurality of pieces of training tag data on the training wireless tag at a plurality of positions of the antenna and the ground truth data indicating the positional relationship of the training wireless tag with respect to the first range. The model processing unit 1016 generates the trained model based on the estimation. The machine learning is, but is not limited to, a neural network.

A plurality of pieces of training phase data change according to a distance between the antenna and the training wireless tag. Distribution of the plurality of pieces of training phase data differs depending on a position of the training wireless tag. There is a certain correlation between the plurality of pieces of training phase data at the plurality of positions of the antenna and the position of the training wireless tag. A plurality of pieces of training Doppler frequency data between a case where the antenna approaches the training wireless tag and a case where the antenna is separated from the training wireless tag. Distribution of the plurality of pieces of training Doppler frequency data differs depending on the position of the training wireless tag. There is a certain correlation between the plurality of pieces of training Doppler frequency data at the plurality of positions of the antenna and the position of the training wireless tag. A plurality of pieces of training RSSI data change according to the distance between the antenna and the training wireless tag. Distribution of the plurality of pieces of training RSSI data differs depending on the position of the training wireless tag. There is a certain correlation between the plurality of pieces of training RSSI data at the plurality of positions of the antenna and the position of the training wireless tag. Thus, there is a certain correlation between the plurality of pieces of training tag data at the plurality of positions of the antenna and the position of the training wireless tag.

The model processing unit 1016 stores the generated trained model in the trained model storage region 1113 (ACT 33).

The generation of the trained model may be implemented by an apparatus other than the reading apparatus 100.

### Modifications

A modification of the communication system 1 will be described.

FIG. 18 illustrates a block diagram of the modification of the communication system 1.

In this modification, the communication apparatus 10 includes an inference apparatus 900. The inference apparatus 900 is an apparatus that can execute processing related to the trained model. The reading apparatus 100 includes a third connection interface for the reading apparatus 100 to communicate with the inference apparatus 900.

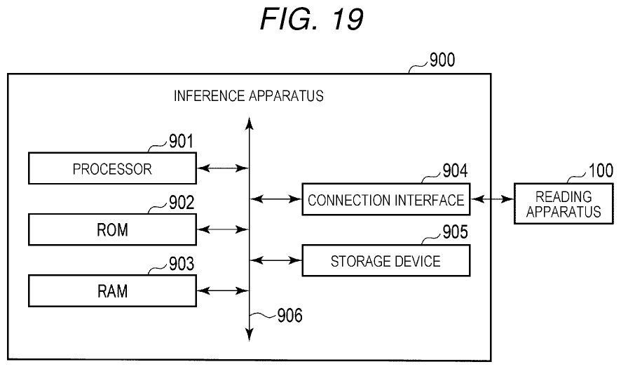

FIG. 19 illustrates a block diagram of an example of a configuration of the inference apparatus 900.

The inference apparatus 900 includes a processor 901, a ROM 902, a RAM 903, a connection interface 904, and a storage device 905. The units provided in the inference apparatus 900 are connected by a bus 906 or the like. A configuration of the processor 901 may be the same as the configuration of the processor 101. A configuration of the ROM 902 may be the same as the configuration of the ROM 102. A configuration of the RAM 903 may be the same as the configuration of the RAM 103. The connection interface 904 is an interface for the inference apparatus 900 to communicate with the reading apparatus 100. A configuration of the storage device 905 may be the same as the configuration of the storage device 111.

The storage device 905 stores the training data. The storage device 905 stores the trained model.

The processor 901 inputs the determination input data to the trained model for each wireless tag 600. The processor 901 acquires the determination output data output from the trained model based on the input of the determination input data to the trained model for each wireless tag 600. The processor 901 generates the trained model by machine learning based on the training data.

An operation example of the reading apparatus 100 and the inference apparatus 900 in the modification will be described. The determination processing unit 1014 of the reading apparatus 100 transmits, via the third connection interface to the inference apparatus 900, the tag data set for each wireless tag 600. The processor 901 of the inference apparatus 900 receives, via the connection interface 904 from the reading apparatus 100, the tag data set for each wireless tag 600. The processor 901 inputs the determination input data to the trained model based on the tag data set for each wireless tag 600. The processor 901 acquires the determination output data output from the trained model based on the input of the determination input data to the trained model for each wireless tag 600. The processor 901 transmits, via the third connection interface to the reading apparatus 100, the determination output data for each wireless tag 600. The determination processing unit 1014 of the reading apparatus 100 receives, via the third connection interface from the inference apparatus 900, the determination output data for each wireless tag 600. Receiving the determination output data is an example of acquiring the determination output data.

### Effects

The communication apparatus 10 determines which range among the first range, the second range, and the third range between the first range and the second range the wireless tag 600 is within.

For example, the wireless tag 600 attached to the article 500 required to be treated as the processing target may protrude from the first range to the third range. The wireless tag 600 attached to the article 500 required to be treated as the processing target may be located on the edge of the first range. The wireless tag 600 attached to the article 500 that is not required to be treated as the processing target may be within the third range. The wireless tag 600 attached to the article 500 that is not required to be treated as the processing target may be located on the edge of the second range. If the communication apparatus 10 determines that the range of such a wireless tag 600 is the first range or the second range, the range of the wireless tag 600 may be erroneously determined. For the wireless tag 600 located at a location difficult to determine as being within the first range or the second range, the communication apparatus 10 can determine that the wireless tag 600 is within the third range. Accordingly, the communication apparatus 10 can avoid erroneously determining that the wireless tag 600 attached to the article 500 required to be treated as the processing target is within the second range. The communication apparatus 10 can avoid erroneously determining that the wireless tag 600 attached to the article 500 that is not required to be treated as the processing target is within the first range. Therefore, the communication apparatus 10 can improve the determination accuracy of the positional relationship of the wireless tag 600 with respect to the first range.

If it is determined that the wireless tag 600 is within the third range, the communication apparatus 10 outputs the input request information.

The communication apparatus 10 can prompt the user to input the range of the wireless tag 600 for the wireless tag 600 located at the location difficult to determine as being within the first range or the second range. Accordingly, the communication apparatus 10 can avoid erroneously determining that the range of the wireless tag 600 is within the first range or the second range.

The third range is a range between the first range and the second range in the horizontal direction.

For example, the wireless tag 600 attached to the article 500 required to be treated as the processing target may come out from a container and protrude from the first range to the third range in the horizontal direction. For the wireless tag 600 located at a location difficult to determine as being within the first range or the second range in the horizontal direction, the communication apparatus 10 can determine that the wireless tag 600 is within the third range. Accordingly, the communication apparatus 10 can avoid erroneously determining that the range of the wireless tag 600 is within the first range or the second range.

The third range is a range between the first range and the second range in the vertical direction.

For example, when the communication apparatus 10 is applied to a picking apparatus, the wireless tag 600 attached to the article 500 that is not required to be treated as the processing target may be located above the picking apparatus. In this case, the wireless tag 600 may be within the third range in the vertical direction. For the wireless tag 600 located at a location difficult to determine as being within the first range or the second range in the vertical direction, the communication apparatus 10 can determine that the wireless is within the third range. Accordingly, the tag 600 communication apparatus 10 can avoid erroneously determining that the range of the wireless tag 600 is within the first range or the second range.

The communication apparatus 10 determines, using the trained model, which range among the first range, the second range, and the third range the wireless tag 600 is within.

The communication apparatus 10 can improve the determination accuracy of the range of the wireless tag 600 by using the trained model.

### Appendix

The embodiment can be expressed as follows.

(1) A communication apparatus including:
a movement control unit configured to control movement of a relative position of an antenna with respect to a wireless tag;
an acquisition unit configured to acquire, based on a radio wave of the wireless tag received by the antenna, a plurality of pieces of tag data on the wireless tag at a plurality of relative positions of the antenna; and
a determination processing unit configured to determine, based on the plurality of pieces of tag data on the wireless tag, which range among a first range, a second range, and a third range between the first range and the second range the wireless tag is within.

(2) The communication apparatus according to (1), further including:
an output unit configured to output, if the determination processing unit determines that the wireless tag is within the third range, information on the wireless tag for prompting a user to input which range of the first range and the second range the wireless tag is within.

(3) The communication apparatus according to (1) or (2), in which a moving direction of the relative position of the antenna is a horizontal direction, and
the third range is a range between the first range and the second range in the horizontal direction.

(4) The communication apparatus according to any one of (1) to (3), in which
a moving direction of the relative position of the antenna is a horizontal direction, and
the third range is a range between the first range and the second range in a vertical direction.

(5) The communication apparatus according to any one of (1) to (4), in which the determination processing unit determines, based on data output from a trained model based on input of the plurality of pieces of tag data on the wireless tag to the trained model, which range among the first range, the second range, and the third range the wireless tag is within.

(6) A communication method including:
controlling movement of a relative position of an antenna with respect to a wireless tag;
acquiring, based on a radio wave of the wireless tag received by the antenna, a plurality of pieces of tag data on the wireless tag at a plurality of relative positions of the antenna; and determining, based on the plurality of pieces of tag data on the wireless tag, which range among a first range, a second range, and a third range between the first range and the second range the wireless tag is within.

### Other Embodiments

In the above-described embodiment, the communication apparatus 10 uses the trained model, but is not limited thereto. The communication apparatus 10 may determine the positional relationship of the wireless tag 600 with respect to the first range without using the trained model. For example, the communication apparatus 10 may determine the positional relationship of the wireless tag 600 with respect to the first range based on a comparison between a threshold value and a difference between a plurality of pieces of tag data on the wireless tag 600.

In the above-described embodiment, an example in which the drive apparatus 200 moves the antenna 300 is described, but the configuration is not limited thereto. The position of the antenna 300 may be fixed, and the drive apparatus 200 may be an apparatus that moves the wireless tag 600. In this example, the drive apparatus 200 may move a stage on which the wireless tag 600 is placed. The stage on which the wireless tag 600 is placed is not limited to a stage that moves in one direction. The stage on which the wireless tag 600 is placed may be a stage having various moving modes such as a rotating stage. Moving the wireless tag 600 is an example of moving the relative position of the antenna 300 with respect to the wireless tag 600. The position of the antenna 300 is an example of the relative position of the antenna 300 with respect to the wireless tag 600. The drive apparatus 200 may be an apparatus that moves both the antenna 300 and the wireless tag 600. Moving both the antenna 300 and the wireless tag 600 is an example of moving the relative position of the antenna 300 with respect to the wireless tag 600. The position of the antenna 300 is an example of the relative position of the antenna 300 with respect to the wireless tag 600.

The communication apparatus may be implemented by a plurality of apparatuses as described in the above example or may be implemented by a single apparatus in which functions of a plurality of apparatuses are integrated. The reading apparatus, the drive apparatus, the antenna, and a measurement device may be implemented by a single apparatus in which functions are integrated. The reading apparatus may be implemented by a plurality of apparatuses with distributed functions.

The above-described embodiment may be applied to not only an apparatus but also a method executed by an apparatus. The above-described embodiment may be applied to a program enabling a computer of an apparatus to execute each function. The above-described embodiment may be applied to a recording medium that stores the program.

The program may be transferred in a state of being stored in an apparatus or may be transferred in a state of not being stored in the apparatus. In the latter case, the program may be transferred via a network or may be transferred in a state of being recorded on a recording medium. The recording medium is a non-transitory tangible medium. The recording medium is a computer-readable medium. A form of the recording medium is not limited as long as the recording medium is a medium that can store the program and can be read by a computer, such as a CD-ROM or a memory card.

Although some embodiments of the disclosure have been described, these embodiments are presented as examples and are not intended to limit the scope of the disclosure. These novel embodiments can be implemented in various other forms, and various omissions, substitutions, and modifications can be made without departing from the gist of the disclosure. These embodiments and modifications thereof are included in the scope and gist of the disclosure, as well as in those recited in the claims and an equivalent scope thereof.

What is claimed is:

1. A communication apparatus, comprising:
a movement controller configured to control movement of a relative position of an antenna with respect to a wireless tag;
an acquisition component configured to acquire, based on a radio wave of the wireless tag received by the antenna, a plurality of pieces of tag data on the wireless tag at a plurality of relative positions of the antenna; and
a determination processing component configured to determine, based on the plurality of pieces of tag data on the wireless tag, which range among a first range, a second range, and a third range between the first range and the second range the wireless tag is within.

2. The communication apparatus according to claim 1, further comprising:
an output component configured to output, if the determination processing component determines that the wireless tag is within the third range, information on the wireless tag for prompting a user to input which range of the first range and the second range the wireless tag is within.

3. The communication apparatus according to claim 1, wherein
a moving direction of the relative position of the antenna is a horizontal direction, and
the third range is a range between the first range and the second range in the horizontal direction.

4. The communication apparatus according to claim 1, wherein
a moving direction of the relative position of the antenna is a horizontal direction, and
the third range is a range between the first range and the second range in a vertical direction.

5. The communication apparatus according to claim 1, wherein
the determination processing component determines, based on data output from a trained model based on input of the plurality of pieces of tag data on the wireless tag to the trained model, which range among the first range, the second range, and the third range the wireless tag is within.

6. The communication apparatus according to claim 1, wherein
the tag data comprises at least one of phase data, Doppler frequency data, and received signal strength indicator data.

7. The communication apparatus according to claim 1, further comprising:
a demodulation component configured to detect the tag data according to movement of the antenna along one direction.

8. A communication method performed by a communication apparatus, the method comprising:
controlling movement of a relative position of an antenna with respect to a wireless tag;
acquiring, based on a radio wave of the wireless tag received by the antenna, a plurality of pieces of tag data on the wireless tag at a plurality of relative positions of the antenna; and
determining, based on the plurality of pieces of tag data on the wireless tag, which range among a first range, a second range, and a third range between the first range and the second range the wireless tag is within.

9. A radio frequency identification (RFID) tag reader, comprising:
a movement controller configured to control movement of a relative position of an antenna with respect to a RFID tag;
an acquisition component configured to acquire, based on a radio wave of the RFID tag received by the antenna, a plurality of pieces of tag data on the RFID tag at a plurality of relative positions of the antenna; and
a determination processing component configured to determine, based on the plurality of pieces of tag data on the RFID tag, which range among a first range, a second range, and a third range between the first range and the second range the RFID tag is within.

10. A non-transitory computer readable storage medium storing a program that causes a computer to execute instructions comprising:
controlling, by the computer, movement of a relative position of an antenna with respect to a wireless tag;
acquiring, based on a radio wave of the wireless tag received by the antenna, a plurality of pieces of tag data on the wireless tag at a plurality of relative positions of the antenna; and
determining, by the computer, based on the plurality of pieces of tag data on the wireless tag, which range among a first range, a second range, and a third range between the first range and the second range the wireless tag is within.
